(19) United States
(12) Patent Application Publication
(10) Pub. No.: US 2026/0336683 A1
(43) Pub. Date: Oct. 29, 2026

(54) Steering Column Assembly with Telescopic Arm and Electromechanical Actuator for Controlling this Arm

(71) Applicant: Robert Bosch GmbH, Stuttgart (DE)

(72) Inventors: Mickael Sauquet, Villerable (FR); Nicolas Genet, Coulommiers La Tour (FR)

(21) Appl. No.: 19/110,298

(22) PCT Filed: Sep. 19, 2023
(86) PCT No.: PCT/EP2023/075776

§ 371 Date: Mar. 10, 2025

(30) Foreign Application Priority Data
Sep. 20, 2022 (FR) FR2209509

(51) Int. Cl. B62D 1/185; B62D 1/181

(52) U.S. Cl. CPC B62D 1/185; B62D 1/181

(57) ABSTRACT

A steering column assembly for a vehicle having a steering wheel includes (i) a frame designed to be permanently mounted on a vehicle structure, (ii) a telescopic arm extending in a longitudinal direction, supported by the frame, and whose longitudinal extension determines the position of a steering wheel, this arm including at least two sections that can be translationally moved, and (iii) an electromechanical actuator for moving the sections in longitudinal translation between an extended position and a retracted position of the arms. The electromechanical actuator includes an electric motor, a motion converter that converts a rotation provided by the electric motor into a translation of the first section, and a transmission system that drives the second section in translation in response to a translation of the first section.

### TECHNICAL FIELD OF THE INVENTION

The present invention relates to the overall field of motor vehicles, and more particularly to a steering column assembly of a vehicle steering system.

### TECHNICAL BACKGROUND

The steering column is one of the components of a vehicle's steering system. It is found on all vehicles and enables communication between the steering wheel and the wheels.

The steering column commonly comprises a fixed bracket rigidly mounted on an element of the body of the vehicle, such as the chassis, and an arm that determines the position of the steering wheel by extending the fixed bracket into the interior of the vehicle, towards the seat on which the driver sits.

In practice, the space between the steering wheel and the seat must be sufficient to allow the driver to sit comfortably on the seat, without having to contort his body to do so. This particular feature is often at odds with the driving position, for which the space measured between the steering wheel and the seat is relatively restricted in order to ensure that the driver has a safe, comfortable grip on the steering wheel.

To solve this problem, it has been proposed to make the arm telescopic, i.e., to enable it to retract and extend. The arm then takes the form of a stepped structure, comprising interlocking sections that can be moved in translation relative to one another.

With this solution, the steering wheel can be moved between a retracted position, in which the steering wheel is far enough from the seat not to interfere with the driver's seating, and an extended position, in which the space between the seat and the steering wheel is reduced. This solution is particularly interesting for equipping a self-driving vehicle, in which a retracted position of the arm can be adopted for comfort reasons in a driving situation that does not require manual trajectory control.

To control the forward movement of the telescopic arm, an electromechanical actuator has been proposed, enabling the steering wheel to be moved with no driver intervention, as opposed to a mechanical actuator which requires manual operation by the driver each time it is used.

Conventional electromechanical actuation systems comprise an electromechanical actuator for moving one section relative to another. Although such a system appears effective for an arm consisting of a combination of only two sections, only one of which moves along the second, it nevertheless limits the maximum travel of the arm. Indeed, unless the length of the telescopic arm sections is increased, and therefore the length of the steering column, which is not always possible given the space available in the vehicle, the arm's travel is structurally and functionally limited.

To achieve a given arm travel length without increasing the overall length of the steering column, it has been proposed to multiply the number of sections moving relative to one another and to provide several actuators, each for moving one section relative to another. However, such a stepped multi-actuator design is beset with certain problems, such as:
increased complexity in assigning actuator commands to the correct set points, and
increased power consumption and noise generation, due either to the need to boost each section's travel speed in the case of cascading actuation of these sections so as to maintain a given actuation time, or to simultaneous actuation of the sections, which requires each actuator to be supplied at the same time with the power it requires to carry out its function.

The invention aims to provide an electromechanical actuating structure for a steering column arm that makes it possible to avoid, at least in part, the aforementioned drawbacks of the conventional solutions.

### DISCLOSURE OF THE INVENTION

To this end the invention relates to a steering column assembly for a steering system of a vehicle, for example of an automobile, comprising:
a frame designed to be permanently mounted on a vehicle structure;
a telescopic arm extending in a longitudinal direction, which is supported by the frame, and whose longitudinal extension determines the position of a steering wheel of the vehicle, this arm including at least two sections that are at least partially nested two by two in succession, the first section being movable in longitudinal translation relative to the frame that supports it, the second section being movable in longitudinal translation relative to the first section while being at least partially nested within this first section,
an electromechanical actuator for moving the sections in translation in the longitudinal direction between an extended arm position, in which the arm is extended to its greatest measured longitudinal extent, and a retracted arm position, in which the arm is retracted to its smallest measured longitudinal extent, this electronic actuator comprising:
-an electric rotary drive motor;
-a motion converter that converts a rotation supplied by the electric motor into a translation of the first section relative to the frame, this motion converter including a driving element and a driven element, the driving element being translationally fixed relative to the frame, the driven element being translationally joined in the longitudinal direction of the first section; and
a transmission system that drives the second section in translation in response to a translation of the first section.

The invention also relates to a steering column assembly thus defined, in which the transmission system drives the second section in translation in response to a translation of the first section, this transmission system comprising:
a threaded rod with a longitudinal axis, which is both translationally joined with the second section and free to rotate around its axis, and
a first nut and a second nut that are fitted to the threaded rod, these first and second nuts each comprising a thread for engaging the threaded rod, the first nut being rotationally locked around the threaded rod and fastened to the frame, the second nut being rotationally locked around the threaded rod and fastened to the second section.

The invention also relates to a steering column assembly thus defined, in which the transmission system drives the second section in translation in response to a translation of the first section, this transmission system comprising:
two wheels that are separated from each other in the longitudinal direction and are rotationally coupled by a belt or chain, these wheels forming pulleys that can each rotate about a respective axis that is translationally joined with the first section;
a first attachment element that connects the belt to the frame; and
a second attachment element that connects the belt to the second section.

The invention also relates to a steering column assembly thus defined, in which the transmission system drives the second section in translation in response to a translation of the first section, this transmission system comprising two successive transmission stages of which:
one is for moving an attachment element that is attached to the frame;
the other is for moving an attachment element that is attached to the second section;
in which each stage comprises:
two pulleys that can be rotated around a respective axis of rotation that is translationally joined with the first section; and
a belt, or chain, that rotationally couples the corresponding pulleys;
and in which:
a single-stage pulley is rotationally coupled to the pulley of the other stage;
the attachment element that is attached to the frame is fastened to the single-stage belt or chain, while the attachment element that is attached to the second section is fastened to the belt or chain of the other stage.

The invention also relates to a steering column assembly thus defined, in which:
the electric motor is fastened to the frame;
the driving element of the motion converter is a screw extending in the longitudinal direction, this threaded rod being rotated by the electric motor and translationally fixed relative to the frame;
the driven element of the motion converter is a nut fitted to the screw, this nut being rotationally locked and translationally joined with the first section.

The invention also relates to a steering column assembly thus defined, in which:
the electric motor is fastened to the first section;
the driving element of the motion converter is a nut that is rotationally locked and fastened to the frame;
the driven element of the motion converter is a screw that extends in the longitudinal direction and is fitted with the nut, this screw being rotated by the electric motor and translationally joined with the first section.

The invention also relates to a steering column assembly thus defined, in which:
the electric motor is fastened to the frame;
the driving element of the motion converter is a pinion with an axis normal to the longitudinal direction, this pinion being rotated around its axis by the electric motor,
the driven element is a rack that is translationally joined with the first section, the pinion being meshed with the rack.

The invention also relates to a steering column assembly thus defined, in which:
the electric motor is fastened to the first section;
the driving element of the motion converter is a rack fastened to the frame;
the driven element is a pinion with an axis normal to the longitudinal direction that is rotated by the electric motor, the pinion being meshed with the rack.

The invention also relates to a steering column assembly thus defined, in which:
the electric motor is fastened to the frame;
the driving element of the motion converter is a wheel with a longitudinal axis, this wheel being delimited by:
   an outer wall with teeth enabling the wheel to be rotated by the electric motor;
   an inner wall with a thread;
the driven element of the motion converter is a screw that screws/unscrews along the inner wall of the wheel, this screw being translationally joined with the first section.

### BRIEF DESCRIPTION OF THE DRAWINGS

Other features and advantages of the invention will become apparent from reading the following detailed description, for the understanding of which reference is made to the appended drawings in which:

FIG. 1 is a perspective view of a steering column assembly according to one embodiment of the invention, comprising a frame, a telescopic arm supported by the frame and an electromechanical actuator for extending/retracting the telescopic arm.

FIG. 2 illustrates the steering column assembly in FIG. 1 from a different point of view, in which part of the frame is hidden to show the electromechanical actuator.

FIG. 3 is a cross-sectional view of the steering column assembly in FIG. 1.

FIG. 4 is a schematic view of the column assembly according to the invention, in which the electromechanical actuator for extending/retracting the telescopic arm comprises a transmission system according to an alternate embodiment.

FIG. 5 is a schematic view of the column assembly according to the invention, in which the electromechanical actuator for extending/retracting the telescopic arm comprises a transmission system according to another alternate embodiment.

FIG. 6 is a schematic and partial view of the column assembly according to the invention, in which the electromechanical actuator for extending/retracting the telescopic arm comprises a motion converter according to an alternate embodiment.

FIG. 7 is a schematic and partial view of the column assembly according to the invention, in which the electromechanical actuator for extending/retracting the telescopic arm comprises a motion converter according to another alternate embodiment.

FIG. 8 is a schematic view of the column assembly according to the invention, in which the electromechanical actuator for extending/retracting the telescopic arm comprises a transmission system according to yet another alternate embodiment.

### DETAILED DESCRIPTION OF THE INVENTION

In the following description, identical, similar or analogous elements will be referred to by the same reference numbers.

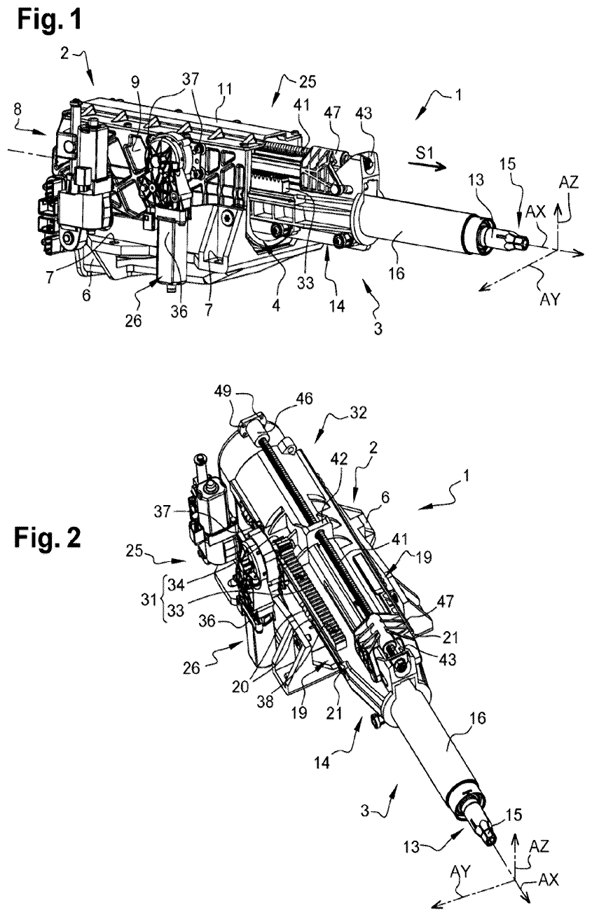

With reference to FIGS. 1 to 3, a steering column assembly 1 for a vehicle steering system is shown, according to one embodiment of the invention. This assembly 1 comprises a frame 2 designed to be fastened to an element of a vehicle body and an arm 3 supported by the frame 2. This arm 3 extends in a longitudinal direction shown by an axis AX.

The frame 2 is in the form of a structure delimiting a housing 4 into which the arm 3 extends at least partially. This frame 2 comprises a baseplate 6 designed to be rigidly attached to the dashboard, chassis or any other element of a vehicle body. To this end, baseplate 6 comprises in particular screw holes numbered 7. The frame 2 further comprises a housing 8 fastened to the baseplate 6. This case 8 is in the form of an assembly between a bracket 9 and a cover 11. The bracket 9 has the overall shape of a channel with a U-shaped longitudinal cross-section. The cover 11 is mounted on the bracket 9 so as to close this U-shaped contour. The housing 4 is jointly delimited by the inner surfaces of the bracket 9 and the cover 11.

The arm 3 surrounds a longitudinal steering shaft 13 that is designed to hold a vehicle steering wheel, not shown, in rigid coupling. More specifically, this steering shaft 13 comprises a free end 15 that projects longitudinally from the arm 3 for insertion into the vehicle steering wheel.

In the example shown in the figures, the free end 15 has a hexagonal contour when viewed in a longitudinal cross-section. However, it should be noted that any other type of shape can be chosen in order to mate with the negative of the recess formed in the steering wheel, into which the free end 15 is inserted. For example, this free end 15 can comprise outer splines that engage with outer splines formed in the corresponding recess of the steering wheel.

In particular, in the context of the invention, the arm 3 is telescopic in nature, meaning it can be extended/retracted relative to the frame 2.

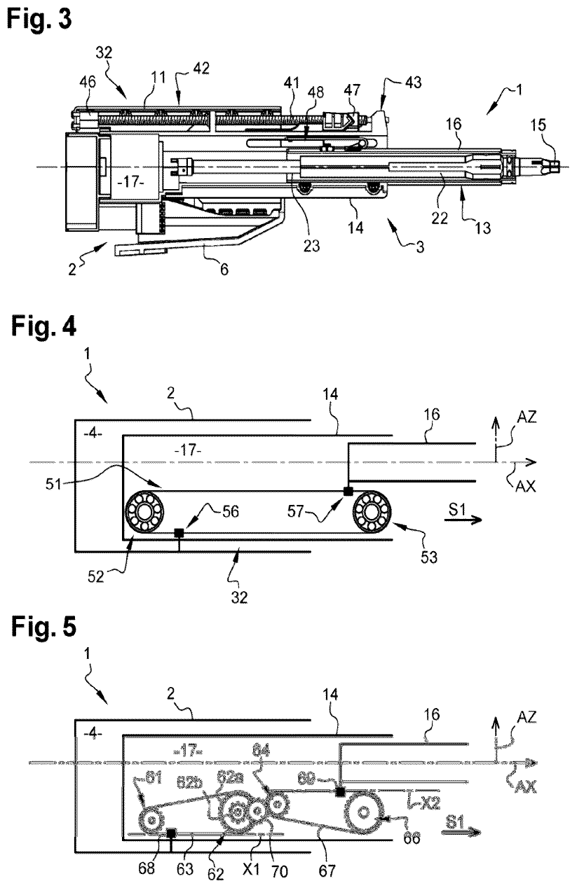

To this end, it comprises a first section 14 and a second section 16 that is nested in the first section 14 and can be moved along this first section 14. Shown in detail in FIG. 3, the first section 14 comprises a through bore 17, with an axis coincident with axis AX, in which the second section 16 is installed with a sliding fit. In the example in the figures, the bore 17 is cylindrical in shape, with a rotational axis coincident with axis AX, but the invention is not limited to this shape. In practice, the bore 17 can have another shape, such as prismatic, without departing from the scope of the invention.

The second section 16 can be longitudinally moved along the bore 17 between a retracted and an extended position. The retracted and extended positions of the second section 16 are designed so that a greater extent of the second section 16 is housed in the bore 17 in the retracted position than in the extended position.

The first section 14 is supported by the frame 2. These two elements are shaped to enable their relative movement in the longitudinal direction, which in practice corresponds to a movement of the first section 14 relative to the frame 2, the frame 2 being fixed once installed in the vehicle.

Longitudinal movement of the first section 14 is limited between a retracted position in which it extends fully into the housing 4, or at least in which a significant portion of this first section 14 extends into the housing 4, and an extended position in which it protrudes longitudinally from the housing 4.

In addition, the steering shaft 13 is telescopic along its length in the arm 3. In particular, the steering shaft 13 is translationally connected to the arm 3, so that extending/retracting the arm respectively extends/retracts the steering shaft 13. Since the steering shaft 13 both supports the steering wheel and is translationally joined with the movement of the arm 3, it follows that the extent to which the arm 3 is extended determines the position of the steering wheel in inside the vehicle. In practice, the arm 3 acts like a muscle: its actuation changes the longitudinal extension of the steering shaft 13 and thereby moves the steering wheel, which is joined with the steering shaft 13.

As shown in detail in FIG. 2, the first section 14 is translationally guided along the housing 4 by two slide rails 19 that extend longitudinally. The slide rails 19 are transversely arranged on either side of the first section 14, along an axis AY perpendicular to axis AX. They are each formed by a pair of grooves that together enclose bearing balls 20. More specifically, each slide rail 19 is formed by the combination of a first groove, not shown, formed on the inner surface of the bracket 9, and a groove 21 formed by the first section 14 facing the first groove. The bearing balls 20 form an interface between the frame 2 and the first section 14.

As is understood, the longitudinal movement of the arm sections 14 and 16 determines the longitudinal extension of the arm 3, and more generally the longitudinal extension of the steering column assembly 1. Overall, the longitudinal extension of the arm 3 can be adjusted between a retracted arm state and an extended arm state, these positions being conditioned by the extended/retracted state of the two sections 14, 16 that make up the arm 3. In practice, the extended state of the arm 3 corresponds to the case in which the first and second sections 14, 16 are each in an extended position, as opposed to the case in which these first and second sections 14, 16 are each in a retracted position, corresponding to the retracted state of the arm 3.

Considering the steering column assembly 1 installed in the vehicle, namely with the fixed frame 2 and the arm 3 extending from the frame 2 towards the driver's seat, then:
extending the telescopic arm 3 corresponds to the translation of the first and second sections 14, 16 in a direction numbered S1, which causes the steering wheel, supported by the steering shaft 13, to move towards the driver's seat; and corollary thereto
retracting the arm 3 corresponds to the translation of the first and second sections 14, 16 in the opposite direction to S1, causing the steering wheel to move away from the driver's seat.

As shown in FIG. 3, the steering shaft 13 is advantageously formed by the combination of two segments 22 and 23, of which a first segment 22 that is translationally connected to the second section 16, and which comprises a free end that constitutes the free end 15 of the steering shaft 13. These segments 22 and 23 are nested one inside the other while extending coaxially and centered along the longitudinal axis AX. They are both rotationally coupled together as interlocking shapes, and can slide relative to each other in the longitudinal direction, so that they can move with the extending/retracting movement of arm 3. In the example shown in FIG. 3, the rotational coupling of the segments 22, 23 is ensured by splines protruding from the radially facing segment surfaces.

The idea behind the invention is to provide a solution that enables combined movement of the first and second sections 14, 16 using the same energy source. In this respect, the steering column assembly 1 according to the invention comprises an electromechanical actuator 25 for extending/retracting the arm 3.

This electromechanical actuator 25 comprises an electric motor 26 that rotates both the first section 14 and the second section 16 of the telescopic arm 3 via a drive mechanism. This drive mechanism comprises two modules that work together:
a motion converter 31 that converts a rotation provided by the electric motor 26 into a translation of the first section relative to the frame 2, and
a transmission system 32 that drives the second section 16 in translation in response to a translation of the first section 14 by the motion converter.

In the example in FIGS. 1 to 3, the motion converter 31 is formed by the combination of a rack 33 and of a pinion 34 that meshes with this rack 33.

Pinion 34 is pivotally mounted around a transversely oriented axis and fastened to the frame 2. This pinion 34 is rotated by the electric motor 26, which is installed in a housing 36 fastened by screws 37 to the bracket 9 on the frame 2. More specifically, the motor output rotation is indirectly transmitted to the pinion 34 via a gearbox, not shown, that is housed in the housing 36. This gearbox ensures a reduction in the rotation speed measured at the output of the electric motor 26, with which it forms a gear unit. Nevertheless, the invention is not limited to this particular arrangement and enables the pinion 34 to be directly driven by the electric motor 26.

The rack 33 extends longitudinally and comprises vertically oriented teeth along an axis AZ orthogonal to the longitudinal axis AX and the transverse axis AY. As shown in detail in FIG. 2, this rack 33 is rigidly fastened to the first section 14 by means of fastening elements numbered 38. It is transversely aligned with the pinion 34 so as to allow them to mesh.

When in operation, namely when the arm 3 is extending/retracting, rotating the pinion 34, which is translationally locked relative to the frame 2, causes the rack 33 to move longitudinally, taking the first section 14 with it as it moves.

In practice, within the motion converter 31 the pinion 34 can be likened to a “driving” element in that it acts on the rack to move it under the action of the electric motor 26, this rack constituting a “driven” element whose movement corresponds to a translation of the first section 14 of the telescopic arm 3.

With regard to the transmission system 32, it comprises, according to the embodiment illustrated in FIGS. 1 to 3, a threaded rod 41 mounted on the first section 14 and extending longitudinally. More specifically, the threaded rod 41 extends along a rod axis that is vertically offset from the axis AX and parallel to this longitudinal orientation axis. This axis AX coincides with the rotational axis of the bore 17 of the first section.

The threaded rod 41 is both translationally joined with the first section 14 and free to rotate around its axis. The first section 14 comprises two bearings 42, 43, specifically provided for this purpose, at each of which the threaded rod 41 is translationally locked while retaining a degree of rotational freedom along the axis of this rod 41.

The transmission system 32 further comprises two nuts 46 and 47 that are fitted on the threaded rod 41 and each have a thread that engages with the thread on the rod 41. The two nuts are numbered as follows:
a first nut 46 that is fastened to the frame 2,
a second nut 47 that is fastened to the second section 16.

In the example in FIG. 3, the second nut 47 is attached to the second section 16 by means of a deformable connection 48, designed to bend if the vehicle is involved in a collision. More specifically, this connection 48 is both riveted to the second nut 47 and welded to the second section 16. With regard to the first nut 46, it is attached to the frame 2 by bolts numbered 49. It should be noted that the attachment of the first and second nuts respectively to the frame 2 and to the second section 16 is not limited to the arrangement in the figures. For example, the second nut 47 can be directly attached to the second section 16, in other words, with no need for a deformable connection 48 as an interface.

When in operation, the first section 14 takes the threaded rod 41 with it in its longitudinal movement induced by the motion converter 31, this rod 41 being mounted on the first section 14. Given that the first nut 46 is fastened to the frame 2 and that the first section 14 is rotationally joined with the frame 2 (and both can only be relatively moved in the longitudinal direction by slide rail connections 19), it follows that longitudinal movement of the threaded rod 41 necessarily requires this threaded rod 41 to rotate around its axis.

Also, given that the extension axis of the threaded rod 41 does not coincide with the rotational axis of the second section, it follows that the second nut 47 cannot be rotated. This aspect necessarily causes the second nut 47 to move along the threaded rod 41 if the threaded rod 41 is rotated.

The operating kinematics of the transmission system 32, and more specifically of the free/translationally locked/rotational state of the first and second nuts 46, 47, has been explained on the basis of the particular arrangement of the threaded rod 41, which does not allow these nuts to rotate. It should be noted that the invention is not limited to such an arrangement of the threaded rod 41, and allows for a different arrangement, provided the three conditions are met: the first nut 46 is translationally joined with the frame 2, being rotationally locked around the axis of the threaded rod 41;
the second nut 47 is translationally joined with the second section 16; and
the threaded rod 41, on which the first nut 46 and the second nut 47 are fitted, is translationally joined with the first section 14.

By way of a non-limiting example, it can be foreseen that the nuts 46, 47 are rotationally locked along the threaded rod 41 by a locking member specifically provided for this purpose, without departing from the scope of the invention.

Overall, when the pinion 34 of the motion converter 31 is rotated by the electric motor 26, it translates the first section 14 by engaging the rack 33 of this motion converter 31. This translation of the first section 14 results in an equally direct translation of the second section 16 by the transmission system 32.

It is understood in the context of the invention that the threaded rod 41 and the nuts 46, 47 have threads that are oriented such that moving the first section 14 from its retracted position to its extended position, in the S1 direction, necessarily also induces a movement of the second section in the S1 direction. As a corollary, a translation of the first section 14 in the opposite direction to S1, imposed by the electric motor 26, results in a translation of the second section 16 also in the opposite direction to S1.

It should be noted that the invention is not limited to the speed of translation of the second section 16 being identical to the speed of translation of the first section 14, even if they move simultaneously. It could in fact be advantageous to provide for a travel speed differential between the two sections 14, 16, particularly if they have different travel lengths between their respective extended and retracted positions.

On the basis of the electromechanical actuator 25 as described in relation to FIGS. 1 to 3, a travel speed differential between the first and second sections can be achieved using different threads on the elements of the transmission system 32. More specifically, the threaded rod 41 can be shaped so that the thread pitch of a portion of its thread that engages the first nut 46 is different from the thread pitch of another portion of its thread that engages the second nut 47.

The steering column assembly 1 is not limited to the described arrangement of the electromechanical actuator 25, in that it comprises a motion converter 31 and transmission system 32, each of which retains its function as described based on the embodiment in FIGS. 1 to 3.

For example, the motion converter 31 is not limited to the arrangement in which the pinion 34 is the driving element while the rack 33 is the driven element. A reverse arrangement can be foreseen without departing from the scope of the invention. In such case, this involves fastening the electric motor 26 relative to the first section 14 and reversing the arrangement of the pinion 34 and the rack 33, namely fastening the transverse rotational axis of the pinion 34 relative to the first section 14 and mounting the rack 33 on the frame 2.

Furthermore, the invention is not limited to the elements constituting the electromechanical actuator 25 as described on the basis of FIGS. 1 to 3.

With reference to FIG. 4, an alternate architecture for the transmission system 32 is provided. In this alternate embodiment, the threaded rod 41 and the pair of nuts 46, 47 are replaced by a belt 51, which connects a pair of wheels 52, 53 forming pulleys. These wheels 52, 53 are longitudinally aligned and translationally joined with the first section 14, and can each rotate around a respective transverse axis fastened to the first section 14. Two attachment elements 56, 57 are each rigidly fastened at a point on a separate belt portion, each separate belt portion being defined as extending between the wheels 52, 53. There is a first attachment element 56 attached to the frame 2 and a second attachment element 57 attached to the second section 16.

Analogous to the assembly formed by the combination of the threaded rod 41 with the pair of nuts 46, 47, this alternate embodiment enables a longitudinal translation of the second section 16 in the S1 direction when the first section 14 is also longitudinally translated in the S1 direction. Conversely, a longitudinal translation of the first section 14 in the opposite direction to S1 generates a longitudinal translation of the second section 16 also in the opposite direction to S1.

The alternate embodiment of the transmission system 32 shown in FIG. 4 does not make it possible to differentiate between the travel speed of the second section 16 and that of the first section 14. This particular feature is made possible by an alternate embodiment to FIG. 4 with multiple belts, such as the one shown in FIG. 5.

This other alternate transmission system 32 is generally in the form of two successive transmission stages, one of which is for moving an attachment element that is attached to the frame 2, while the other is for moving an attachment element that is attached to the second section 16. Each of these stages comprises two pulleys, which can be rotated around a respective transverse axis and are translationally joined with the first section 14, and a belt that rotationally couples them. Rotational coupling of a single-stage pulley to a pulley of the other stage is provided to ensure rotational transmission between the two stages. In addition, the attachment element attached to the frame is rigidly fastened to one of the two belts, while the attachment element attached to the second section 16 is rigidly fastened to the other of these belts.

In the example in FIG. 5, there is:
a first stage formed by the combination of a first wheel 61, a compound gear 62 and a first belt 63. The compound gear 62 comprises a toothed pulley wheel 62a, which is rotationally coupled to the first pulley wheel 61 by the first belt 63. This compound gear 62 further comprises a pinion 62b that is concentric and rigidly connected to the gear 62a with a diameter smaller than this gear;
a second stage formed by the combination of a second pulley wheel 64 and a third pulley wheel 66, which are rotationally coupled by a second belt 67;
a reduction gear that rotationally couples the pinion 62b, forming the first-stage transmission output, to the second wheel 64, forming the second-stage transmission input. The reduction gear is advantageously formed by an idler wheel 70, which can be rotated around a respective transverse axis and is fastened to the first section 14, which meshes with the pinion 62b and the second wheel 64;
an attachment element 68 that is attached to the frame 2 and to the first belt 63;
an attachment element 69 that is attached to the second section 16 and to the second belt 67.

In this example, the first wheel 61 has a smaller diameter than the diameter of the toothed wheel 62a, each forming a first-stage transmission pulley, and in a complementary manner, the second wheel 64 has a smaller diameter than the diameter of the third wheel 66, each forming a second-stage transmission pulley. As is understood, this particular arrangement imparts a travel speed to the second belt 67 that is lower than that of the first belt 63. It follows that the longitudinal travel speed of the second section 16 is lower than the longitudinal travel speed of the first section 14.

In this alternate embodiment of the transmission system 32, it is advantageously provided that the pulley axes are orthogonally offset so that the portion of the pulley to which the corresponding attachment element is fastened is longitudinally oriented strictly along an axis numbered X1 or X2 in FIG. 5. This particular feature aims to compensate for the measured difference in diameter between the pulleys, so as not to impede the longitudinal movement of the sections 14, 16 of the arm 3.

Another solution is to provide attachment elements 68, 69 with variable geometry in the orthogonal direction to compensate for an orthogonal moving component of the belts 63, 67.

It should be noted that this alternate embodiment is not limited to the dimensions of the elements described. In the example shown, the first wheel 61 has a smaller diameter than the diameter of the toothed wheel 62a, and the second wheel 64 has a smaller diameter than the diameter of the third wheel 66. As stated, this arrangement imparts a longitudinal travel speed to the second section 16 that is lower than the longitudinal travel speed of the first section 14.

However, the invention is not limited to this particular arrangement. Conversely, a longitudinal travel speed of the second section 16 greater than the longitudinal travel speed of the first section 14 can be achieved by:
changing the diameter difference sign between the pulleys of each stage; and
substituting the nature of toothed wheel 62a-pinion 62b in compound gear 62 by inverting the value of their diameters.

Lastly, it should be noted that the alternate embodiments described on the basis of FIGS. 4 and 5 are not limited to the use of belts in the strict sense. The belt or belts can be replaced by a chain or chains to achieve a similar result. Similarly, any type of belt/chain can be used without departing from the scope of the invention, and the morphology (teeth, splines, etc.) of the pulleys can be changed as required to ensure satisfactory coupling.

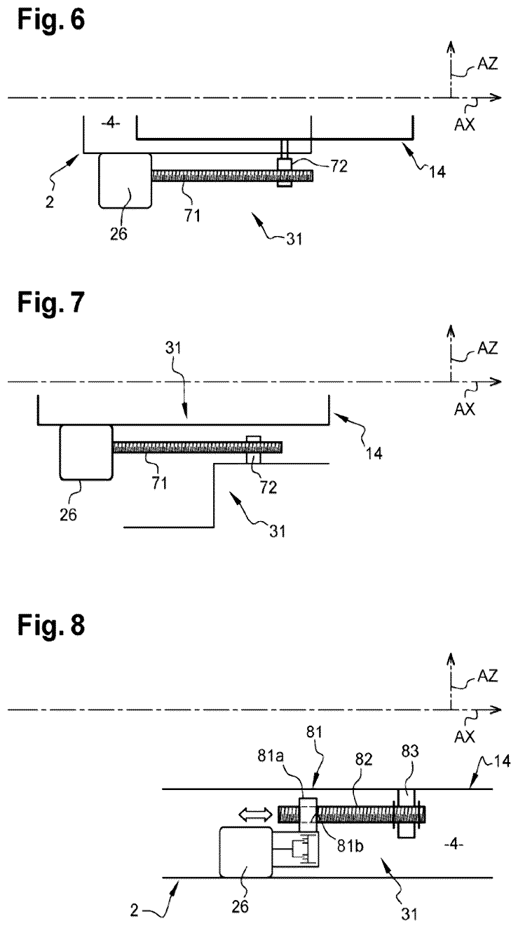

With reference to FIGS. 6 to 9, alternate embodiments of the motion converter 31 are provided.

According to a first alternate embodiment illustrated in FIG. 6, the rack 33-pinion 34 assembly of the example in FIGS. 3 to 5 is replaced by a screw 71-nut 72 assembly.

The screw 71 extends in the longitudinal direction, being both translationally locked relative to the frame 2 and rotatable around its axis. This screw 71 is fitted with the nut 72, which is fastened to the first section 14 of the telescopic arm 3 and rotationally locked relative to the screw 71.

The screw 71 is coupled to the electric motor 26, also fastened to the frame 2, so that when the electric motor rotates the screw 71, it moves the nut 72 along the screw and consequently longitudinally displaces the first section.

In this case, the screw 71 corresponds to a driving element of the motion converter 31, while the nut 72 corresponds to a driven element.

A second alternate illustrated in FIG. 7 corresponds to the reverse arrangement of the first alternate illustrated in FIG. 6, in which. As is understood, in this case the nut 72 corresponds to the driving element, while the screw 71 corresponds to the driven element of the motion converter 31.

Lastly, FIG. 8 illustrates a third alternate embodiment of the motion converter 31 that comprises a toothed wheel 81, a screw 82 and a pivot 83.

With reference to this FIG. 8, the toothed wheel 81 is delimited by an outer wall 81a and an inner wall 82b in which:
the outer wall 81a is toothed so that it can be rotationally coupled with the electric motor 26 fastened to the frame 2; and
the inner wall 81b comprises a thread.

The screw 82 extends in the longitudinal direction and engages with the toothed wheel 81. More specifically, the screw 82 comprises a thread that engages with the thread on the inner wall 81b of the toothed wheel.

Moreover, the screw 82 is pivotally mounted on the first section 14, and is supported by the pivot 83 which is fastened to the first section 14.

With this arrangement, when the electric motor 26 rotates the toothed wheel 81, the screw 82 is screwed in/unscrewed, causing the first section to move in translation.

1. A steering column assembly for a steering system of a vehicle, comprising:
a frame designed to be permanently mounted on a vehicle structure;
a telescopic arm extending in a longitudinal direction, which is supported by the frame and whose longitudinal extension determines the position of a steering wheel of the vehicle, the arm including at least two sections that are at least partially nested two by two in succession, the first section being movable in longitudinal translation relative to the frame that supports it, the second section being movable in longitudinal translation relative to the first section while being at least partially nested within the first section; and
an electromechanical actuator configured to move the sections in translation in the longitudinal direction between (i) an extended arm position, in which the arm is extended to its greatest measured longitudinal extent, and (ii) a retracted arm position, in which the arm is retracted to its smallest measured longitudinal extent,
wherein the electromechanical actuator comprises:
an electric rotary drive motor;
a motion converter configured to convert a rotation supplied by the electric motor into a translation of the first section relative to the frame, the motion converter including a driving element and a driven element, the driving element being translationally fixed relative to the frame, and the driven element being translationally joined in the longitudinal direction of the first section; and
a transmission system configured to drive the second section in translation in response to a translation of the first section.

2. The steering column assembly according to claim 1, wherein:
the transmission system is configured to drive the second section in translation in response to a translation of the first section, and
the transmission system comprises:
a threaded rod with a longitudinal axis, which is both translationally joined with the second section and free to rotate around its axis, and
a first nut and a second nut that are fitted to the threaded rod, the first and second nuts each comprising a thread for engaging the threaded rod, the first nut being rotationally locked around the threaded rod and fastened to the frame, and the second nut being rotationally locked around the threaded rod and fastened to the second section.

3. The steering column assembly according to claim 1, wherein:
the transmission system is configured to drive the second section in translation in response to a translation of the first section, and
the transmission system comprises:
two wheels that are separated from each other in the longitudinal direction and are rotationally coupled by a belt or chain, the wheels forming pulleys that are configured to each rotate about a respective axis that is translationally joined with the first section;
a first attachment element that connects the belt to the frame; and
a second attachment element that connects the belt to the second section.

4. The steering column assembly according to claim 1, wherein:
the transmission system is configured to drive the second section in translation in response to a translation of the first section, and
the transmission system comprises two successive transmission stages, wherein:
one is configured to move an attachment element that is attached to the frame;
the other is configured to move an attachment element that is attached to the second section;
also wherein each stage comprises:
two pulleys configured to be rotated around a respective axis of rotation that is translationally joined with the first section; and
a belt, or chain, that is configured to rotationally couple the corresponding pulleys;
and further wherein:
a single-stage pulley is rotationally coupled to the pulley of the other stage; and
the attachment element that is attached to the frame is fastened to the single-stage, belt while the attachment element that is attached to the second section is fastened to the belt, or chain, of the other stage.

5. The steering column assembly according to claim 1, wherein:
the electric motor is fastened to the frame
the driving element of the motion converter is a screw extending in the longitudinal direction, the threaded rod being rotated by the electric motor and translationally fixed relative to the frame; and
the driven element of the motion converter is a nut fitted to the screw, the nut being rotationally locked and translationally joined with the first section.

6. The steering column assembly according to claim 1, wherein:
the electric motor is fastened to the first section;
the driving element of the motion converter is a nut that is rotationally locked and fastened to the frame; and
the driven element of the motion converter is a screw that extends in the longitudinal direction and is fitted with the nut, the screw being rotated by the electric motor and translationally joined with the first section.

7. The steering column assembly according to claim 1, wherein:
the electric motor is fastened to the frame;
the driving element of the motion converter is a pinion with an axis normal to the longitudinal direction, the pinion being rotated around its axis by the electric motor; and
the driven element is a rack that is translationally joined with the first section, the pinion being meshed with the rack.

8. The steering column assembly according to claim 1, wherein:
the electric motor is fastened to the first section;
the driving element of the motion converter is a rack fastened to the frame; and
the driven element is a pinion with an axis normal to the longitudinal direction that is rotated by the electric motor, the pinion being meshed with the rack.

9. The steering column assembly according to claim 1, wherein:
the electric motor is fastened to the frame
the driving element of the motion converter is a wheel with a longitudinal axis, the wheel being delimited by (i) an outer wall with teeth enabling the wheel to be rotated by the electric motor, and (ii) an inner wall with a thread; and
the driven element of the motion converter is a screw configured to screw and unscrew along the inner wall of the wheel, the screw being translationally joined with the first section.

10. The steering column assembly according to claim 1, wherein the vehicle is an automobile.
